(19) United States
(12) Patent Application Publication
(10) Pub. No.: US 2016/0135584 A1
(43) Pub. Date: May 19, 2016

(54) SAFETY STATION

(71) Applicant: Bullay, LLC, Elizabeth, CO (US)

(72) Inventors: Kathy Freeman, Strasburg, CO (US); Charles Frumveller, Elizabeth, CO (US)

(21) Appl. No.: 14/939,922

(22) Filed: Nov. 12, 2015

Related U.S. Application Data
(60) Provisional application No. 62/080,220, filed on Nov. 14, 2014.
(60) Provisional application No. 62/118,258, filed on Feb. 19, 2015.

(51) Int. Cl. A47B 3/08; A62C 99/00; A47B 13/00

(52) U.S. Cl. CPC A47B 3/08; A47B 13/00; A62C 99/009

(57) ABSTRACT

Disclosed are embodiments of a safety station system, which may include one or more legs comprising a surface contacting portion and a platform coupling portion, and a platform including a leg coupling portion and an accessory coupling portion, the leg coupling portion coupled to the platform coupling portion of the one or more legs, where at least one of the one or more legs further includes a canister receiving portion configured to receive and secure a canister, where at least one of the one or more legs further includes an accessory receiving portion configured to allow accessories to be coupled to the one or more legs, where the one or more legs are configured to pivot with respect to the platform from a closed position to an operable position.

### CROSS REFERENCE TO RELATED APPLICATIONS

This application claims priority to, and benefit from, provisional patent application Ser. No. 62/080,220, entitled “SAFETY STATION”, filed Nov. 14, 2014, and patent application Ser. No. 62/118,258, entitled “SAFETY STATION”, filed Feb. 19, 2015, which are both incorporated by reference for all purposes.

### BACKGROUND

Construction sites may be required by OSHA to have fire extinguishers, hazardous material spill kits, first aid kits, SDS, other safety information, as well as other safety materials. Foreman and supervisors may be required to have similar or the same materials with them.

Sometime the safety equipment is stored at a temporary office or trailer at the job site. The workers may be a relatively long distance away from the office while working.

Many times on a job site the first aid kits are usually not there or a good distance from the employees. The fire extinguishers may be not located near the actual worksite or be able to be found at all, and may be in an entirely different location from the first aid kit.

### OVERVIEW

In various embodiments a safety station is provided. The safety station may include one or more legs, a platform, and optionally other accessories. The safety station may be configured to be generally portable and placed almost anywhere at a construction or other work site. It may be advantageous to place the safety station near where workers are working for added safety.

In an embodiment, one of the legs may be configured with, or to accommodate, a fire extinguisher, such as a 5 pound or 10 pound fire extinguisher. Another leg may be configured with or to hold a first aid kit. Another leg may be configured with hooks or other attachment configurations to hold safety paperwork, SDS, etc. All of the legs may include orifices to receive hooks, rings or other connection apparatus' or methods.

An accessory may include a water cooler holder, ice chest holder, water cup holder, and/or safety flag connection configuration, to enumerate a few possible accessories. Accessories may be configured to couple to the platform, or to the legs.

### BRIEF DESCRIPTION OF THE DRAWINGS

FIG. 1 illustrates an elevation view of a safety station in an operable position or configuration, according to an embodiment.

FIG. 2 illustrates various views of an example leg.

FIG. 3 illustrates a top view of a safety station, according to an embodiment.

FIG. 4 illustrates a bottom view of a safety station, according to an embodiment.

FIG. 5 illustrates various views of a platform, according to an embodiment.

FIG. 6 illustrates a five gallon water cooler holder accessory, according to an embodiment.

FIG. 7 illustrates a ten gallon water cooler holder accessory, according to an embodiment.

FIG. 8 illustrates an ice chest holder accessory, according to an embodiment.

### DETAILED DESCRIPTION

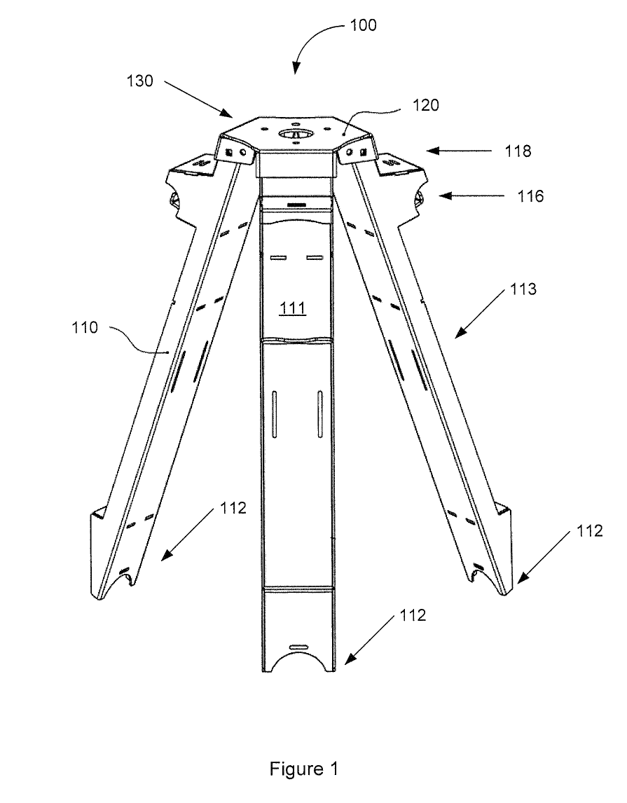

FIGS. 1-8 and the following description depict specific embodiments of the invention to teach those skilled in the art how to make and use the best mode of the invention. For the purpose of teaching inventive principles, some conventional aspects have been simplified or omitted. Those skilled in the art will appreciate variations from these embodiments that fall within the scope of the claimed disclosure. Those skilled in the art will appreciate that the features described below can be combined in various ways to form multiple embodiments and variations of the invention. As a result, the invention is not limited to the specific embodiments described below, but only by the claims and their equivalents.

FIG. 1 illustrates a safety station system 100. Safety station 100 may include one or more legs 110 which are configured to couple to a platform 120. System 100 may optionally include an accessory receiving portion 130 configured to couple adjacent the platform 120. The legs 110 are configured to couple to the platform 120, such that the legs 110 can pivot from an operational position shown here, to a closed position where the legs are generally adjacent each other.

A worker or supervisor may transport the system 100 in the closed position. The system 100 may include one or more straps configured to couple to various portions of the leg, platform 120, or other portion of the system 100, such that a user could easily carry, store and/or transport the system 100 in the closed position. The system 100 may be in the operable position (as shown), placed on a surface near workers. In the operational position, the system 100 may be stable and sturdy and be able to be placed or secured to many different surface types and grades.

This configuration may make it easier to transport the system 100 and place it near workers. Furthermore, it may include all safety equipment required by OSHA for a particular job type and site. It may include a fire extinguisher, first aid kit, AED, water cooler, disposable cups, and all safety and other paperwork, as well as other items.

In this embodiment, system 100 is shown with three legs 110. It will be appreciated that other numbers of legs may be used as wanted or needed, such as one leg, 2 legs, or more than three legs.

As shown, one leg 111 may be configured to receive and secure a fire extinguisher. A leg may be configured to receive and secure a first aid kit. Leg 113 may also include integral hooks 116. Furthermore leg may include a leg coupling portion 118, which may configured generally as a hook or other configuration where external hooks and other items may be coupled to a leg 110. External hooks may also be attached to the platform 120 via various orifices in the legs 110. A strap may be coupled at or near portion 118 to facilitate carrying the system.

A leg 110 may also be configured to allow other accessories and items to be coupled to the system 100, such as a clip board, disposable cup holder, instruments, tools, extension cords, flashlight, eye wash kit, soap or sanitizer dispenser for hand wash station etc., for good housekeeping methods required by OSHA, among other reasons.

Most first aid kits and fire extinguishers are kept in the foreman's truck or in a job trailer, which may be far from workers. This system 100 may allow the foreman or supervisor to take the first aid kit & extinguisher out of his truck and make it readily available to workers per OSHA requirements. Many times foreman leave the jobsite for various reasons, leaving the crew with no fire extinguisher or first aid kit at all. By making this system 100 portable and weather proof this makes it easier for a company to maintain safety while meeting OSHA requirements.

Furthermore, first aid kits that are in the job trailers are typically not portable, so the larger kits that house most of the necessary first aid supplies for a major injury are not portable. If there was an incident which occurred, personnel would have to grab all supplies needed and carry it to the injured person. The system 100 would eliminate multiple trips and lesson time of injury not being cared for.

Many companies have two sets of first aid kits, one with the foreman & one in the job trailer. They keep this as a backup to ensure OSHA compliance. With this system 100 meeting OSHA first aid kit requirements for up to 100 people. This will allow a company to purchase the one kit & keep it readily available to crews at a work site at all times. This will be safer, save money on OSHA fines, and save time, among other considerations.

The system 100 may be made of lightweight durable materials. In one embodiment, the system 100 is made from aluminum, which is weather proof, rust proof, and generally durable for construction job sites. In another embodiment, the system 100 may be made from plastic and/or composite material, to make the system 100 more lightweight and less costly.

The surface contacting portion 112 of the leg is designed to either work on indoor construction sites or will allow for the stand to be pushed into the dirt, offering a sturdy first aid safety station that can withstand against weather elements. The system 100 may also include a ground securing member (not shown), such as a device that will hook to a leg and secure it to the ground. In one example, the ground securing member may have a screw portion that screws into the ground, and a hook portion that hook onto the leg, or otherwise secured to a leg.

Not only will the system 100 house the first aid kit & fire extinguisher it can also hold job specific paperwork. By doing this virtually everything that is required on the jobsite by OSHA, MSHA, and/or other safety requirements may be housed in one central location. Many times when a job site inspection is being performed, the foreman has to walk to his truck to get paperwork or has misplaced it somewhere on the job.

OSHA 1926.24 Subpart C requires that the employer shall be responsible for the development and maintenance of an effective fire protection and prevention program at the job site throughout all phases of the construction, repair, alteration, or demolition work. The employer shall ensure the availability of the fire protection and suppression equipment required by Subpart F of this part.

OSHA section 1926.150(a)(1) states “The employer shall be responsible for the development of a fire protection program to be followed throughout all phases of the construction and demolition work, and he shall provide for the firefighting equipment as specified in this subpart. As fire hazards occur, there shall be no delay in providing the necessary equipment.”

Section 1926.150(a)(2) states “Access to all available firefighting equipment shall be maintained at all times. Section 1926.150(a)(3) states “All firefighting equipment, provided by the employer, shall be conspicuously located.” Section 1926.150(a)(4) states “All firefighting equipment shall be periodically inspected and maintained in operating condition. Defective equipment shall be immediately replaced.”

OSHA medical requirements include section 1926.50(d)(1), which states “First aid supplies shall be easily accessible when required. Section 1926.50(d)(2) states “The contents of the first aid kit shall be placed in a weatherproof container with individual sealed packages for each type of item, and shall be checked by the employer before being sent out on each job and at least weekly on each job to ensure that the expended items are re-placed.”

The system 100 meets all of these requirements. The system 100 may be a generally lower cost option for the employer to meet all of these OSHA requirements, while providing a safer jobsite and thereby reducing risk and associated costs. The portability of the system would allow for easy transport and deployment of the system 100 at many different jobsites.

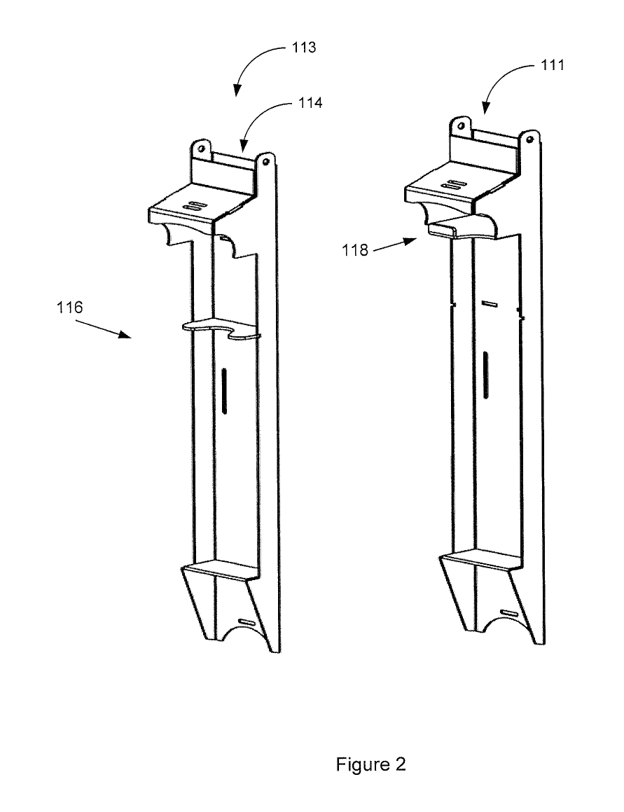

FIG. 2 is an illustration of various views of example legs 110, 111, 113. This is only an embodiment of legs, and other configurations may be used without straying from the spirit and scope of this disclosure. This disclosure is not intended to be limited with respect to the various embodiments shown.

Legs 110, 111, 113 may include a platform coupling portion 114, configured to couple to platform 120 in a generally pivoting type manner.

Leg 111 may also include a leg accessory receiving portion 118. Leg accessory receiving portion 118 is configured to receive accessories, such as a first aid kit, cup dispenser, clipboards, etc.

Leg 113 may include a canister receiving portion 116. Canister receiving portion 116 is configured to receive and secure a canister, such as a fire extinguisher or other canister type item.

It will be appreciated that other leg configuration may be used for various purposes, including the securing of other accessories.

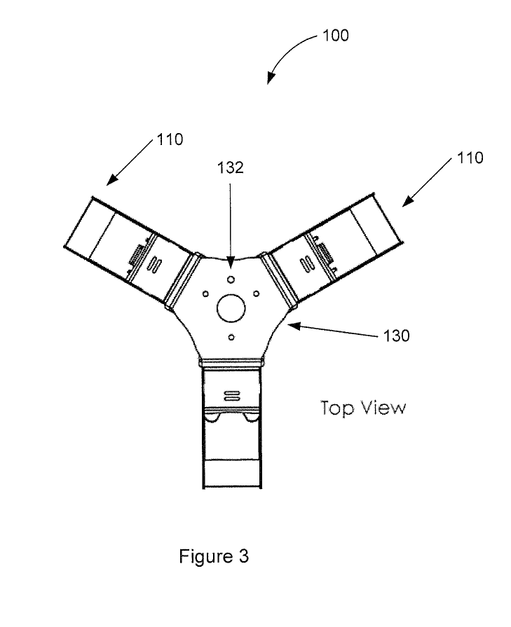

FIG. 3 illustrates a top view of an example system 100. System 100 may include one or more legs 110, as well as accessory receiving portion 130. Accessory receiving portion 130 is configured to receive and secure a water cooler, such that the workers will be provided with water on the jobsite, among other accessories. This may be required by the union or other contract, as well as by OSHA. Alternatively, receiving portion 130 may be configured receive and secure a hand wash station, Ice chest, larger cooler, or other accessory or item, as needed or desired.

Portion 130 may also include orifices for securing an accessory, as well as an orifice 132 for receiving a safety flag, or other generally circular or cylindrical accessory. A tube (not shown) may be attached to any of the orifices in portion 130 to better secure a flag, beacon, or other accessory.

Portion 130 may also be configured to receive and secure a generally square, or any other shaped, cooler, a warning light, a flashing strobe light, a sign or sign support, a flag and/or a flag support, an eye wash station, an AED or AED mount, ice chest, and/or a flash light holder, and/or other item or accessory, and/or combinations thereof.

The system may also include a solar charging station to power various devices, such as the strobe, warning light, or any other device. This charging system may be used to charge communication devices, such as cell phone, walkie-talkie, or other communication devices.

In this example, receiving portion 130 may be integral with platform 120. In another example, portion 130 may be coupled adjacent a top side of platform 120. It will be appreciated that other configurations and coupling positions may be used.

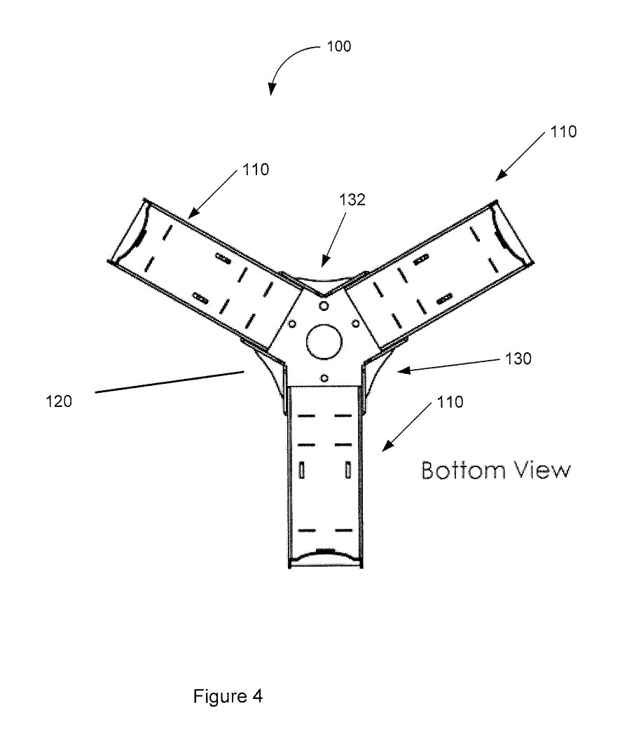

FIG. 4 illustrates a bottom view of an example system 100 in the operational position with legs 110 extended. Legs 110 are coupled to platform 120. Also shown an accessory receiving portion 130 and securing portion 132.

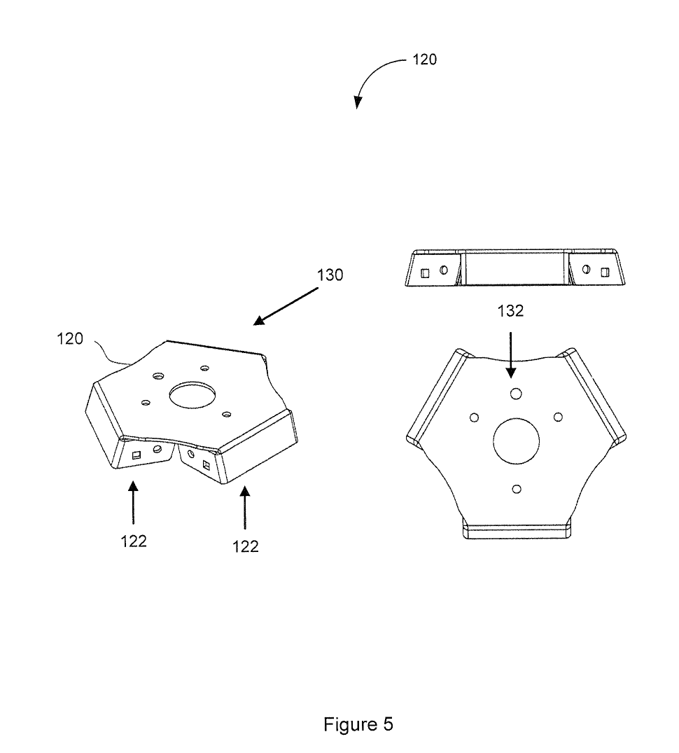

FIG. 5 illustrates plan elevation and bottom views of an example platform portion 120. Platform 120 may include leg receiving portions 122 and receiving portion 130. Receiving portion 130 may be generally at the top of platform 120, and may be integral with platform 120, or be coupled to platform 120.

Legs 110 may be coupled to platform 120 via bolts, tabs, or other connection configurations. In one example, legs are coupled to platform in a pivoting type manner to allow the legs 110 to be folded generally inwardly, toward each other. When the legs 110 are in this position, the system 100 in the closed, stored, or non-operational configuration. In the extended position, the legs are generally away from each other to allow the system 100 to be deployed or operational configuration.

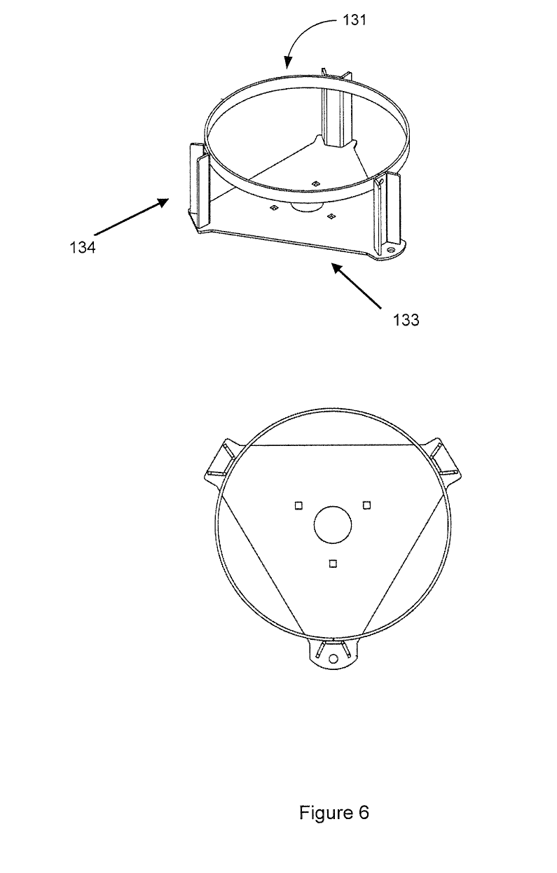

FIG. 6 illustrates a perspective and top views of an example five gallon cooler accessory 131. Cooler accessory 131 may include a platform coupling portion 133 and cooler securement portion 134.

Platform coupling portion 133 is configured to couple to the receiving portion 130 of platform 120. In an example, Accessory 131 may couple to the platform via bolts, screws or other securing configuration and method. Cooler securement portion 134 is configured to receive and generally secure a round or other shaped water cooler for the job site.

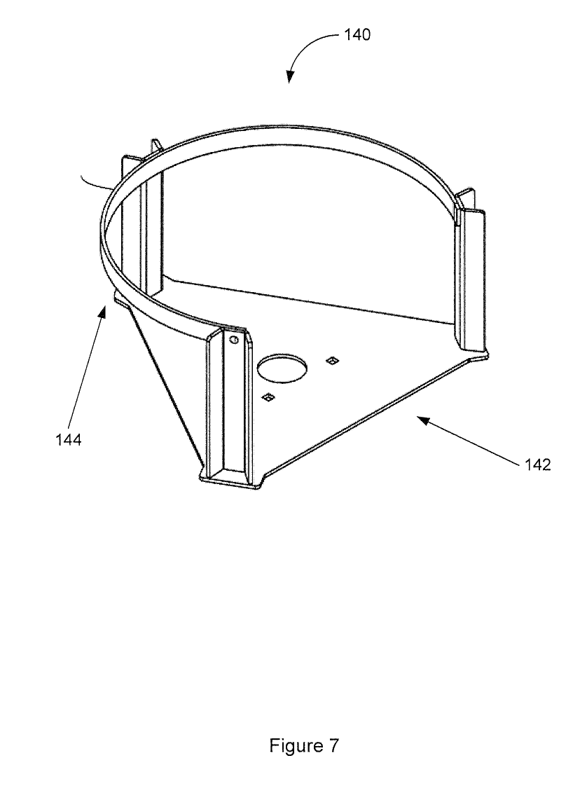

FIG. 7 is a perspective view of an example 10 gallon cooler accessory 140. Accessory 140 includes a platform securing portion 142, configured to secure accessory 140 to the platform 120 or other part of the system 100. Accessory 140 also includes a cooler securing portion 144, configured to secure a 10-gallon cooler, or other accessory. Cooler securing portion is not a complete circle to allow for insertion of the accessory where the accessory includes a spout or other portion extending away from the accessory.

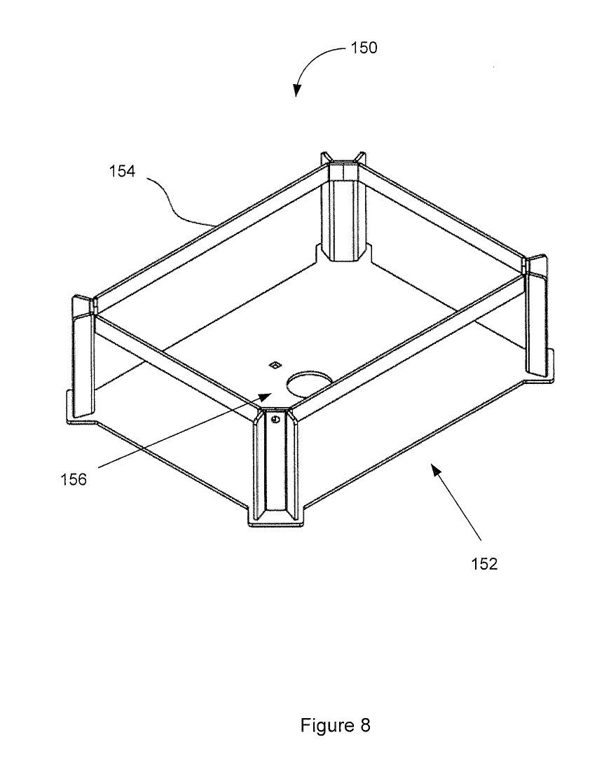

FIG. 8 is a perspective view of an example ice chest accessory 150. Accessory 150 includes a platform securing portion 152, configured to secure accessory 150 to the platform 120 or other part of the system 100. Accessory 150 also includes a chest securing portion 154, configured to secure an ice chest, or other accessory.

Securing portion 152 also includes orifice 154, which may be configured to allow a safety flag, beacon, or other item to extend therethrough, and through a corresponding orifice of the platform, when an ice chest or other item is not with the system 100.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A safety station system, comprising:
one or more legs comprising a surface contacting portion and a platform coupling portion;
a platform comprising at least one leg coupling portion and an accessory coupling portion, the leg coupling portion coupled to the platform coupling portion of the one or more legs; and
an accessory receiving portion coupled to the platform adjacent the accessory coupling portion of the platform;
wherein at least one of the one or more legs further comprises a canister receiving portion configured to receive and secure a canister,
wherein at least one of the one or more legs further comprises a leg accessory receiving portion configured to allow accessories to be coupled to the one or more legs.

2. The system of claim 1, wherein the one or more legs are configured to pivot with respect to the platform from a closed position to an operable position.

3. The system of claim 1, wherein the canister comprises a fire extinguisher.

4. The system of claim 1, wherein the accessory receiving portion comprise a general hook-type configuration capable of coupling safety documentation to the at least one of the one or more legs.

5. The system of claim 1, wherein the safety station system is generally about 2-5 feet in height.

6. The system of claim 1, wherein the at least one or more legs is made from aluminum.

7. The system of claim 1, wherein the one or more legs are made from a composite material.

8. The system of claim 1, wherein the one or more legs, the platform portion, and/or the cooler receiving portion comprise metal, plastic, polymer, composite, wood, or combinations thereof.

9. The system of claim 1, wherein at least one of the one or more legs comprises a leg accessory receiving portion configured to receive a disposable cup holder.

10. A safety station system, comprising:
three legs each comprising a surface contacting portion and a platform coupling portion;
a platform comprising a leg coupling portion and an accessory coupling portion, the leg coupling portion coupled to the platform coupling portion of each the three legs; and
an accessory comprising a platform coupling portion coupled to the accessory coupling portion of the platform, configured to general secure an accessory;
wherein at least one of the one or more legs further comprises a fire extinguisher receiving portion configured to receive and secure a fire extinguisher,
wherein at least one of the three legs further comprises a leg accessory receiving portion configured to allow accessories to be coupled to at least one of the legs,
wherein the three legs are configured to pivot with respect to the platform from a closed position to an operable position.

11. The system of claim 10, wherein the accessory receiving portion of the at least one leg comprises hooks capable of coupling safety documentation to the at least one of the one or more legs.

12. The system of claim 10, wherein the one or more legs, the platform portion, and/or the cooler receiving portion comprise metal, plastic, polymer, composite, wood, and/or combinations thereof.

13. The system of claim 10, wherein the accessory is configured to secure a water cooler or an ice chest.

14. The system of claim 10, wherein the platform further comprises an orifice configured to receive a safety flag or a portion of a safety beacon.

15. A safety station system, comprising:
one or more legs comprising a surface contacting portion and a platform coupling portion; and
a platform comprising a leg coupling portion and an accessory coupling portion, the leg coupling portion coupled to the platform coupling portion of the one or more legs; and
wherein at least one of the one or more legs further comprises a canister receiving portion configured to receive and secure a canister,
wherein at least one of the one or more legs further comprises an accessory receiving portion configured to allow accessories to be coupled to the one or more legs,
wherein the one or more legs are configured to pivot with respect to the platform from a closed position to an operable position.

16. The system of claim 15, further comprising an accessory receiving portion coupled to the platform adjacent the accessory coupling portion of the platform.

17. The system of claim 15, wherein the canister comprises a fire extinguisher.

18. The system of claim 15, wherein the safety station system is generally about 2-5 feet in height, and about 10-35 pounds.

19. The system of claim 15, wherein the one or more legs, the platform portion, and/or the accessory receiving portion comprise metal, plastic, polymer, composite, wood, and/or combinations thereof.

20. The system of claim 15 further comprising a strap coupled to the leg or other portion to facilitate carrying of the system when in the closed or operable position.
